(19) United States
(12) Patent Application Publication
(10) Pub. No.: US 2012/0096859 A1
(43) Pub. Date: Apr. 26, 2012

(54) AIR- AND STEAM-TECHNOLOGY COMBINED SOLAR PLANT

(75) Inventors: Raúl Navio Gilaberte, Sevilla (ES); Lucia Serrano Gallar, Sevilla (ES); Paula Llorenter Folch, Sevilla (ES); Noelia Martinez Sanz, Sevilla (ES); Sandra Alvarez De Miguel, Sevilla (ES); Javier Asensio Perez-Ullivarri, Sevilla (ES)

(73) Assignee: ABENGOA SOLAR NEW TECHNOLOGIES, S.A., Sevilla (ES)

(21) Appl. No.: 13/257,486

(22) PCT Filed: Mar. 18, 2010
(86) PCT No.: PCT/ES10/00110

§ 371 Date: Nov. 8, 2011

(30) Foreign Application Priority Data
Mar. 20, 2009 (ES) P200900764

(51) Int. Cl. F03G 6/00; F24J 2/07; F22B 33/00

(52) U.S. Cl. 60/641.8; 122/1 R

(57) ABSTRACT

Air- and steam-technology combined solar plant for use in the fields of electricity production, process heat, and solar fuels, as well as thermo-chemical processes, produced from the combination of a non-pressurised-air solar receptor, a saturated-steam solar receptor and a heat exchanger separate from the solar input that is used to produce overheated steam.

### TECHNICAL FIELD OF THE INVENTION

The present invention relates to a solar plant with application in the fields of electricity production, process heat and solar fuels, as well as thermo-chemical processes, which aims to combine the technologies of air solar receptor and saturated-steam solar receptor for the production of superheated steam.

### BACKGROUND OF THE INVENTION

The technology inside which the invention is framed and which is the object of this patent is the technology of tower thermoelectric solar power plants, in which a field of heliostats (large mirrors, 40-125 m2 per unit) equipped with a tracking of the solar position at all times (elevation and azimuth), guide the reflected rays to a light placed on top of a tower.

Direct solar energy is concentrated in a receptor at the top of a tower. These receptors have a heat transfer fluid that is heated from the concentrated solar energy.

Later this or any other fluid heated from the above passes through a turbine, for electricity production.

There are a variety of receptor types that fulfil the mission of collecting the concentrated solar energy and transmitting it to a heat transfer fluid, but they all still have a number of drawbacks.

Next we will refer to three types of receptors depending on the type of heat transfer fluid employed: saturated-steam solar receptors, superheated steam solar receptors and air solar receptors.

The generally tubular saturated-steam solar receptors heat the water that passes by the receptor occurring in them the phase change and obtaining steam at certain temperature. These receptors, however, reach as maximum steam temperatures of 330° C., for which the yield of the turbine can be considered low.

As a solution to this, the use of superheated steam solar receptors was raised, the use of which allows the implementation of more efficient thermodynamic cycles in plants. However, these receptors have a great technological difficulty due to the stringent conditions of temperature at which the receptor is operated.

The walls of the tubes of the superheated steam solar receptor are subjected to thermal cycling continuously between room temperature, the temperature of the steam that feeds this receptor (250 to 310° C.) and the required temperature on the wall for the generation of superheated steam at 540° C., close to 600° C., this coupled with the lack of controllability of the system especially in the event of transients, (passing clouds etc.) and poor thermal properties of the superheated steam, causes that the receptor materials are exposed to significant stress, suffer greater stress and fatigue and resulting in cracking due to large temperature differences in different parts of the receptor.

On the other hand there is the problem of working at high pressure, requiring larger tube wall thicknesses, that when transferring high power densities to the heat transfer fluid necessarily imply high thermal gradients.

Thus the difficulties that are found currently in the superheated steam systems are mainly linked to the resistance of materials due to solar input conditions.

Another type of receptors that are found is air receptors with or without pressurization.

These receptors are generally volumetric receptors that are specifically designed to optimize heat exchange with air as thermal fluid, the illuminated absorber constituting the receptor being a matrix or porous medium (wire mesh or ceramic monolith), through which the cooling gas flows.

These receptors can work at an outlet temperature between 700° C. and 850° C. for metal absorbers and more than 1,000° C. with ceramic absorbers but with thermal efficiencies lower than those of tubular receptors (70-80%).

Pressurized air receptors use air heated by solar radiation and then injected into a gas turbine at a certain pressure.

In these receptors we are again on the condition of working at very high pressures, with the difficulties of control that this implies in a solar power plant, which also has not a constant heat input.

It is also important to consider that in a solar receptor, the incident flux distribution, even in quasi-stationary state is not uniform over the surface of the receptor. In addition, the incident flux has discontinuities due to the variation of cloud passage, called transients. These two factors give us a real idea of the thermal-structural stresses which a solar receptor has to undergo.

So far the receptors described above have been considered independently in electric production solar plants or constituting a single receptor. The combination of both receptors independently located on towers housed in one or several cavities would be a huge advantage with the intention of solving the various technical problems posed above.

The invention presented below tries to bring together the advantages of using superheated steam on solar power plants, solving the existing risks, achieving greater control of the plant and thereby increasing the stability and durability of this.

### DESCRIPTION OF THE INVENTION

This invention is proposed as an alternative to existing technologies that use a single receptor to generate superheated steam by using solar energy input.

There are included improvements to existing technologies because the main object (obtaining superheated steam at certain conditions to power a turbine), is reached by carrying out a stepwise process occurring in solar components physically independent, which is why the technological advantages provided by each one of them can be used. The implementation of a system as the one described herein, will allow obtaining greater efficiency in the overall electricity production process.

The invention consists of the production of high efficiency superheated steam by combining three elements: not pressurized air solar receptor, saturated-steam solar receptor and a heat exchanger. The system also has a boiler where the phase separation of the water-steam mixture from the saturated steam receptor takes place.

In this combined air and saturated-steam receptor system, both receptors are physically separated, therefore each receptor can be placed in one single cavity or different cavities of the tower, which can lead to the establishment of independent strategies of heliostat field pointing. The pointing strategy of the heliostats consists of an adaptive dynamic control of the field according to the requirements of heat flux density of each receptor, thereby maintaining stable temperature conditions of entry of fluids to the exchanger. Thus, part of the heliostat field is focused on the saturated steam receptor and another part on the air receptor, allowing greater control of the plant and promoting the stability of operation of the same.

In the proposed system, overheating of the saturated steam (from the boiler) takes place in a heat exchanger, which is separated from the solar input, and in which the transfer fluid is not pressurized air at high temperature from a solar receptor at atmospheric pressure. Thus, the increase of the temperature of steam is obtained as a result of energy transfer between the fluids from the two receptors in the exchanger.

The foregoing implies a huge advantage for the proposed system against superheated steam receptors, as now the exchanger can have easily controlled input and output conditions, which may stabilize the stage of overheating.

Similarly, when performing the steam overheating of the receptors in a exchanger separated from the solar input, reducing the instability of doing it in a superheated steam receptor is achieved. This will prevent the problems caused by the stringent conditions of temperature to which the receptor is subjected, and which cause problems of resistance of materials (high voltages, extreme mechanical and thermal fatigue conditions) causing the appearance of cracks in its structure.

There is a possibility that the air leaving the exchanger at a temperature above 80° C. is used for pre-heating the water recirculated to the boiler and that will be distributed later to the saturated steam receptor.

Another advantage of the proposed system is the fact of working with non-pressurized air receptors that have a great simplicity of operation and allow preventing the problems caused by the use of pressurized air in unstable incident solar radiation conditions. On the other hand, the steam input is carried out by saturated-steam solar receptors, which technology has no technological risks.

The separation of the evaporation and overheating phases also allows having a greater margin of maneuver when implementing thermal storage systems in the circuit, by using saturated steam or superheated steam, thereby guaranteeing the operation of the plant at those moments of the day when there are transients (clouds, etc . . . ) or solar input is not available.

Therefore, the combined use of these two types of receptors (non-pressurized air receptor and saturated steam receptor) in a solar plant for the production of superheated steam from a heat exchanger is a huge advantage in order to improve the overall system efficiency, the stability of the different stages of the process and the durability of the elements that form it.

In summary, the improvements and advantages of this invention compared to existing technologies for central tower solar receptors are:
Combined use of saturated steam receptor and air receptor technology, for obtaining fluids at optimum conditions that allow overheating of steam in an independent heat exchanger, which facilitates control of the solar plant and favours its continued normal operation and stability. These components are physically separated for greater efficiency in the different stages of the process and allow greater control over it.
Overheating is carried out in a heat exchanger independent from the solar receptors, which will attenuate the difficulties carried by superheated steam solar receptors, making the process to be carried out in a more efficient and controlled manner.
Due to the physical independence of both receptors, these can be placed in the same cavity (without forming a single receptor) or in different cavities of the tower, in this case being able to carry out a certain pointing strategy of the field according to the requirements of each receptor.
The process allows raising the possibility of developing and implementing thermal storage systems with greater margin for maneuver by using saturated steam or superheated steam.
Reduction of thermal stresses to which the materials of the receptors are subjected when using an external heat exchanger for overheating, favouring the durability of the plant.

### DESCRIPTION OF THE DRAWINGS

To complement the description being made and in order to help to a better understanding of the characteristics of the invention, as an integral part of said description, is attached a set of drawings wherein by way of illustration and not limitation, the following has been represented (according to a preferred embodiment of the same):

FIG. 1. Single cavity tower central technology solar plant with a combination of saturated steam receptor and air receptor, where the references correspond to the following elements:

1. Heliostat field: A set of large mirrors (40-120 m2) that concentrate direct solar radiation on top of the receptor.

2. Single cavity tower.

3. Cavity, the purpose of which is to house the receptors of different technologies

4. Non-pressurized air receptor: in said receptor air temperature is raised by providing solar energy.

5. Saturated steam receptor: receptor over which solar energy is focused in order to produce saturated steam.

6. Boiler

7. Heat exchanger: A device for heat exchange between the hot air input and superheated steam.

8. Turbine

9. Capacitor

10. Pump

11. Current of water supply to the boiler which is then sent to the saturated steam receptor

12. Saturated steam obtained in the saturated steam receptor

13. Hot air from the non-pressurized air receptor

14. Cooler air recirculated to the non-pressurized air receptor

15. Recovered and condensed water from the turbine recirculated to the boiler for subsequent bypassing to the saturated steam receptor

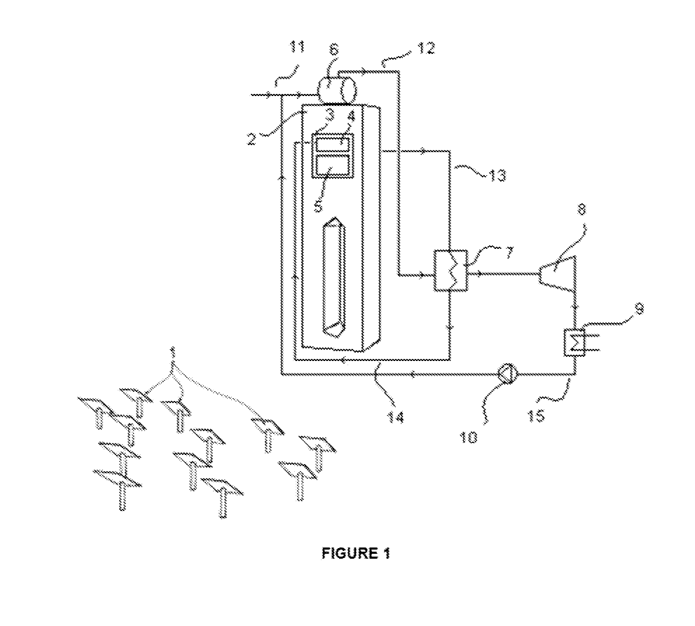

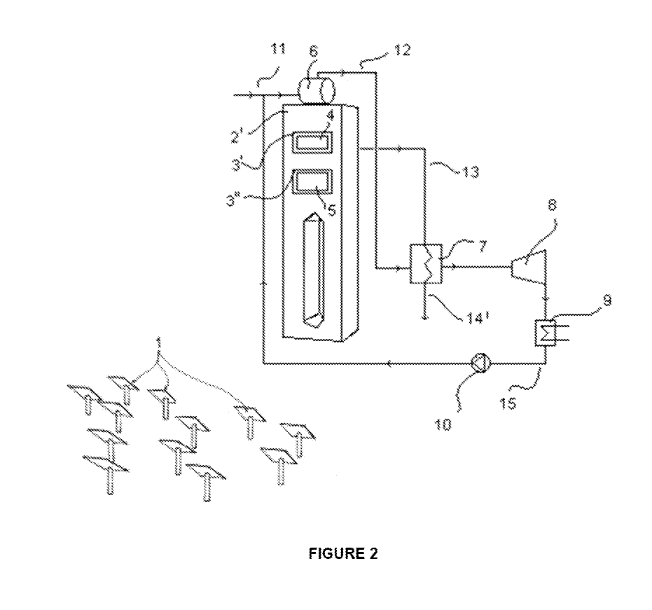

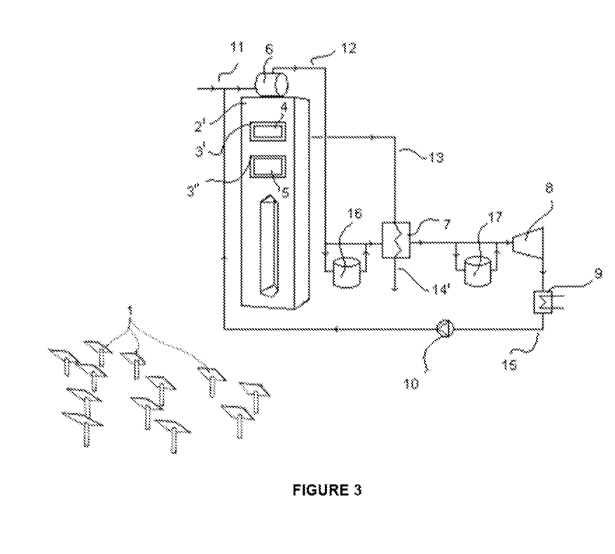

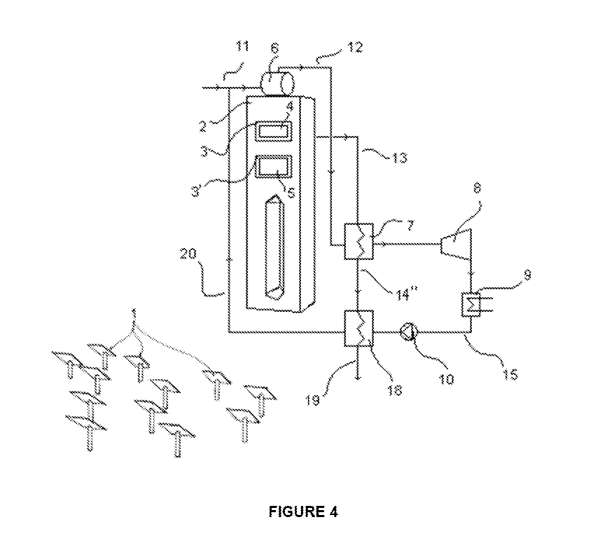

FIG. 2. Two cavities tower central technology solar plant with a combination of saturated steam receptor and air receptor, where the references that differ from FIG. 1 represent:

2′. Two cavities tower

3′, 3″. Cavities

14′. Cooler air exiting the exchanger

FIG. 3. Two cavities tower central technology solar plant, with a combination of saturated steam receptor and air receptor, with thermal storage systems, where the new references represent:

16. Thermal storage system for saturated steam

17. Thermal storage system for superheated steam

FIG. 4. Two cavities tower central technology solar plant, with a combination of saturated steam receptor and air receptor with economizer, where the new elements correspond to the references:

14″. Cooler air exiting the exchanger for water preheating

18. Economizer

19. Low temperature air

20. Preheated water for boiler supply

### PREFERRED EMBODIMENT OF THE INVENTION

The thermoelectric solar plant object of our invention consists of an optimal height tower (2, 2′) and a field of heliostats (1) (large mirrors 40-120 m2), together with the auxiliaries needed for the operation of this.

The tower has two cavities located at the top of the tower (3′, 3″), one for housing a saturated-steam solar receptor (5) and another one for a non-pressurized air solar receptor (4). For the solar energy input to the two receptors occurs in the most efficient manner it is proposed to carry out a series of pointing strategies of heliostats so that part of the heliostat field to the saturated-steam solar receptor and part to the superheated steam receptor, i.e., it is proposed the use of concentrated radiation by a percentage of the heliostat field for the evaporation stage, and the use of the rest of the field for the concentration of radiation intended for the non-pressurized air receptor.

The supply water (11) enters cold in the boiler (6) and from there it circulates to the saturated-steam solar receptor (5) where part of the liquid water turns into steam. The water-steam mixture, rises again to the boiler (6) where the phase separation takes place. Saturated steam (12) leaves the boiler at a temperature between 260-350° C., said temperature will be given by the pressure of the steam system.

Air (13) from the non-pressurized solar receptor (4) installed in the first cavity of the tower (3′) and heated by solar radiation concentration is introduced into a heat exchanger (7). In it, heat exchange occurs between the air at high temperature (13) and saturated steam (12) from the boiler (6) of the saturated-steam solar receptor installed in a second cavity (3″) of the tower. The temperature of the superheated steam will be that required by the steam turbine (8), usually 540° C. Therefore, the design of the air receptor will have an area and a focus of a number of heliostats proportional to the power required by the turbine (8).

The heat exchanger (7) is situated next to the tower (2′) to facilitate its maintenance and reduce costs associated with its installation.

After the air-steam exchanger, there is an output of superheated steam to turbine and an output of air still at high temperature (14, 14′, 14″) that can be used as an economizer (18) or system for pre-heating water from the turbine (15), as a system of hot air for entry to the air receptor or in the case of large-scale major power plants as reheater of the steam at the output of a high pressure turbine which will subsequently feed a medium pressure turbine.

Our thermoelectric solar plant can also have a storage system (16) in steam or molten salts, which allows us to store the steam generated in the solar receptor in order to use it overnight in the absence of solar input or during transients.

1. Air- and steam-technology combined solar plant, which uses as heat transfer fluid water/steam and air, characterized by having three subsystems: a first subsystem of evaporation and a second air subsystem physically located separately in the same cavity or in different cavities of a tower; and a third subsystem of overheating by an air-steam heat exchanger independent from the prior subsystems and including a boiler as a connection between the evaporation and the overheating subsystems.

2. Air- and steam-technology combined solar plant according to claim 1, characterized by carrying out a control of pointing strategies of the heliostat field independent for the first two subsystems.

3. Air- and steam-technology combined solar plant according to claim 2, characterized that the heat exchange occurs in an external element not subjected to the input of solar energy.

4. Air- and steam-technology combined solar plant according to claim 2, characterized in that it combines the use of one or more non-pressurized air receptors and one or more saturated steam receptors.

5. Air- and steam-technology combined solar plant according to claim 4, characterized in that the saturated steam receptor is tubular or exterior.

6. Air- and steam-technology combined solar plant according to claim 4, characterized in that the non-pressurized air receptors and the saturated steam receptors are located in the same cavity.

7. Air- and steam-technology combined solar plant according to claim 4, characterized in that the non-pressurized air receptors and the saturated steam receptors are located in different cavities.

8. Air- and steam-technology combined solar plant according to claim 6 or 7, characterized in that the thermoelectric solar plant has one or several thermal storage systems.

9. Air- and steam-technology combined solar plant according to claim 6 or 7 characterized in that an exchange system between the air leaving the exchanger and the water fed to the boiler is used as a preheating.

10. Air- and steam-technology combined solar plant according to claim 6 or 7 characterized in that an exchange system between the air at the output of the exchanger and the steam exiting from a high pressure turbine is used for its heating and subsequent supply to a medium pressure turbine
